(19) United States
(12) Patent Application Publication
(10) Pub. No.: US 2016/0150459 A1
(43) Pub. Date: May 26, 2016

(54) TECHNIQUES TO SUPPORT HETEROGENEOUS NETWORK DATA PATH DISCOVERY

(71) Applicant: QUALCOMM Incorporated, San Diego, CA (US)

(72) Inventors: Abhishek Pramod Patil, San Diego, CA (US); George Cherian, San Diego, CA (US); Santosh Paul Abraham, San Diego, CA (US)

(21) Appl. No.: 14/944,554

(22) Filed: Nov. 18, 2015

Related U.S. Application Data
(60) Provisional application No. 62/081,666, filed on Nov. 19, 2014.

(51) Int. Cl. H04W 40/02; H04L 12/733; H04L 12/911; H04L 12/721

(52) U.S. Cl. CPC H04W 40/02; H04L 45/72; H04L 45/20; H04L 47/825

(57) ABSTRACT

Methods, systems, and devices are described for discovering and establishing an optimal data path between a source device and a destination device of a first network by employing one or more other networks having a network protocol different from the first network. The techniques of the present disclosure may include receiving a route request message from the source device at an edge device connected to both a first network and a second network, and forwarding the route request message via the second network. In some examples, the data path that offers an improved link metric and/or a minimum hop count may be established by routing traffic along a data path employing a plurality of networks (e.g., WLAN, cellular or Ethernet) between the source device and the destination device.

### CROSS REFERENCES

The present Application for Patent claims priority to U.S. Provisional Patent Application No. 62/081,666 by Patil et al., entitled “Techniques to Support Heterogeneous Hybrid Wireless Mesh Protocol Routing,” filed Nov. 19, 2014, and assigned to the assignee hereof.

### BACKGROUND

The following relates generally to wireless communication, and more specifically to techniques to support heterogeneous network data path discovery. Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more station (STA) or other mobile devices. The AP may be coupled to a network, such as the Internet, and may enable a mobile device to communicate via the network (and/or communicate with other devices coupled to the access point). A wireless device may communicate with a network device bi-directionally. For example, in WLAN, a STA may communicate with an associated AP via downlink (DL) and uplink (UL) communication links. The DL (or forward link) may refer to the communication link from the AP to the station, and the UL (or reverse link) may refer to the communication link from the station to the AP.

An alternative to the traditional method of networked communication includes a network that lacks centralized infrastructure (e.g., an infrastructure-less network), such as a wireless mesh network, where associated devices may form networks without base stations, access points or equipment other than the mobile devices themselves. Wireless mesh networks are dynamically self-organized and self-configured with stations in the network automatically establishing an ad-hoc network with other stations such that the network connectivity is maintained. In a mesh network topology, data originating from or terminating at a station may be routed via a plurality of intermediate stations. Thus, in some examples, paths for the data between a plurality of stations may be circuitous, or traverse an unnecessarily large number of devices, which may negatively impact end-to-end latency associated with such communications.

### SUMMARY

Systems, methods, and apparatuses for heterogeneous network data path discovery are described. The techniques of the present disclosure may include configuring a network device (e.g., a network node) having multi-network capability to determine and subsequently select a data path between the source device and the destination device that employs heterogeneous networks. In some examples, the route that offers a favorable link metric and/or a minimum hop count may be established by forwarding route request messages over a plurality of networks (e.g., wired or wireless networks employing various network protocols such as those associated with WLAN, cellular, or Ethernet networks) between the source device and the destination device. For example, according to aspects of the present disclosure, a data path that employs a plurality of networks may be discovered and established, which may improve one or more link metrics such as increasing throughput, reducing packet loss, reducing latency, increasing voice quality, increasing connect rate, and/or reducing retransmission rate between a source device and a destination device.

For example, a communication system including a network employing a hybrid wireless mesh protocol (HWMP) may provide node discovery and communications procedures for an infrastructure-less mesh network formed by a plurality of STAs. In some examples, two or more STAs of the communication system may support communications over multiple networks having heterogeneous protocols, such as the network employing HWMP and another network employing a wired Ethernet protocol, and such devices may be referred to as edge devices and/or edge nodes. According to aspects of the present disclosure, the communication system may employ a discovery protocol in which the edge devices are configured to forward route request messages over the multiple networks (e.g., forward route request messages via both the HWMP network and the Ethernet network), and various devices of the communication system may determine that a data path between a source device and a destination device of the HWMP network may benefit from a portion of the data path traversing the Ethernet network. Once a data path has been established between the source device and the destination device, subsequent data can be forwarded between the source device and the destination device over the established data path, which in some examples may include a data path employing heterogeneous networks. Therefore, forwarding route request messages over heterogeneous networks according to aspects of the present disclosure may overcome, for example, limitations associated with path discovery within a single network.

A method for communication networking is described. The method may include: receiving, at an edge device connected to a first network and a second network, a route request message from a source device via the first network; identifying, at the edge device, a destination device within the first network based at least in part on the route request message; forwarding the route request message via the second network; and determining, based at least in part on the forwarded route request message, whether traffic between the source device and the destination device that is routed through the edge device should be directed via the first network or via the second network.

An apparatus for communication networking is described. The apparatus may include a processor, memory in electronic communication with the processor, and instructions stored in the memory. The instructions may be executable by the processor to cause the apparatus to: receive, at an edge device connected to a first network and a second network, a route request message from a source device via the first network; identify, at the edge device, a destination device within the first network based at least in part on the route request message; forward the route request message via the second network; and determine, based at least in part on the forwarded route request message, whether traffic between the source device and the destination device that is routed through the edge device should be directed via the first network or via the second network.

Another apparatus for communication networking is described. The apparatus may include: means for receiving, at an edge device connected to a first network and a second network, a route request message from a source device via the first network; identifying, at the edge device, a destination device within the first network based at least in part on the route request message; forwarding the route request message via the second network; and determining, based at least in part on the forwarded route request message, whether traffic between the source device and the destination device that is routed through the edge device should be directed via the first network or via the second network.

A non-transitory computer-readable medium storing code for communication networking is described. The code may include instructions executable to: receive, at an edge device connected to a first network and a second network, a route request message from a source device via the first network; identify, at the edge device, a destination device within the first network based at least in part on the route request message; forward the route request message via the second network; and determine, based at least in part on the forwarded route request message, whether traffic between the source device and the destination device that is routed through the edge device should be directed via the first network or via the second network.

In some examples of the method, apparatuses, or non-transitory computer-readable medium the second network may employ a network protocol different from a network protocol employed by the first network. In some examples of the method, apparatuses, or non-transitory computer-readable medium, determining whether traffic should be directed via the first network or via the second network may include steps, means, features, or instructions for receiving a route reply message from the destination device, the route reply message based at least in part on the forwarded route request message. In some examples the route request message is a path request message (PREQ) according to a hybrid wireless mesh protocol (HWMP).

In some examples of the method, apparatuses, or non-transitory computer-readable medium, determining whether traffic should be directed via the first network or via the second network may include steps, means, features, or instructions for determining, based at least in part on the forwarded route request message, that a data path via the second network provides at least one of a favorable link metric, or minimum hop count, or a combination thereof between the source device and the destination device as compared to a data path via the first network.

In some examples of the method, apparatuses, or non-transitory computer-readable medium, forwarding the route request message via the second network may include steps, means, features, or instructions for incrementing a hop count of the route request message.

In some examples of the method, apparatuses, or non-transitory computer-readable medium, forwarding the route request message via the second network may include steps, means, features, or instructions for tunneling a packet comprising the route request message and having a format associated with a protocol employed by the first network inside a frame having a format associated with a protocol employed by the second network; and broadcasting the frame over the second network. In some examples the frame may include an identification that the source device and the destination device are within the first network. In some examples the frame may include at least one of a neighbor awareness network (NAN) cluster identification (ID), a NAN data link group ID, a mesh ID, a medium access control (MAC) address of the source device, or a MAC address of the destination device.

In some examples of the method, apparatuses, or non-transitory computer-readable medium, determining whether traffic should be directed via the first network or via the second network may be based at least in part on one or both of: a predetermined characteristic of a data path from the edge device to the destination device via the first network, or a predetermined characteristic of a data path from the edge device to the destination device via the second network.

Some examples of the method, apparatuses, or non-transitory computer-readable medium may include steps, means, features, or instructions for receiving, at the edge device, a data packet originating from the source device to be received by the destination device; encapsulating the data packet inside a data frame having a format associated with the second network; and forwarding the data frame from the edge device along an established data path via the second network, the established data path based at least in part on the determining whether traffic should be directed via the first network or via the second network.

A method for communication networking is described. The method may include: receiving, at an edge device connected to a first network and a second network, a frame via the second network; extracting, from the frame, a packet comprising a route request message from a source device of the first network to a destination device of the first network; and forwarding, via the first network, the packet comprising the route request message via the first network.

An apparatus for communication networking is described. The apparatus may include a processor, memory in electronic communication with the processor, and instructions stored in the memory. The instructions may be executable by the processor to cause the apparatus to: receive, at an edge device connected to a first network and a second network, a frame via the second network; extract, from the frame, a packet comprising a route request message from a source device of the first network to a destination device of the first network; and forward, via the first network, the packet comprising the route request message via the first network.

Another apparatus for communication networking is described. The apparatus may include: means for receiving, at an edge device connected to a first network and a second network, a frame via the second network; means for extracting, from the frame, a packet comprising a route request message from a source device of the first network to a destination device of the first network; and means for forwarding, via the first network, the packet comprising the route request message via the first network.

A non-transitory computer-readable medium storing code for communication networking is described. The code may include instructions executable to: receive, at an edge device connected to a first network and a second network, a frame via the second network; extract, from the frame, a packet comprising a route request message from a source device of the first network to a destination device of the first network; and forward, via the first network, the packet comprising the route request message via the first network.

Some examples of the method, apparatuses, or non-transitory computer-readable medium may include steps, means, features, or instructions for: receiving a data frame at the edge device; determining the destination device based at least in part on the data frame; extracting a data packet from the data frame; and forwarding the data packet along an established data path from the edge device via the first network, the established data path based at least in part on the forwarded packet comprising the route request message.

In some examples of the method, apparatuses, or non-transitory computer-readable medium, the second network may employ a network protocol different from a network protocol employed by the first network. In some examples of the method, apparatuses, or non-transitory computer-readable medium, the route request message is a path request message (PREQ) according to a hybrid wireless mesh protocol (HWMP).

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a communication system configured for heterogeneous network data path discovery in accordance with aspects of the present disclosure

FIGS. 2A and 2B illustrate an example of a communications system configured for heterogeneous network data path discovery in accordance with aspects of the present disclosure;

FIG. 3 illustrates an example of a call flow diagram for heterogeneous network data path discovery in accordance with aspects of the present disclosure;

FIG. 4 shows a block diagram of a communication device configured for heterogeneous network data path discovery in accordance with aspects of the present disclosure;

FIG. 5 shows a block diagram of a communication device configured for heterogeneous network data path discovery in accordance with aspects of the present disclosure;

FIG. 6 shows a block diagram of a heterogeneous network communication manager configured for heterogeneous network data path discovery in accordance with aspects of the present disclosure;

FIG. 7 illustrates a block diagram of a system including a STA configured for heterogeneous network data path discovery in accordance with aspects of the present disclosure;

FIG. 8 shows a flowchart illustrating a method for heterogeneous network data path discovery in accordance with aspects of the present disclosure;

FIG. 9 shows a flowchart illustrating a method for heterogeneous network data path discovery in accordance with aspects of the present disclosure;

FIG. 10 shows a flowchart illustrating a method for heterogeneous network data path discovery in accordance with aspects of the present disclosure;

FIG. 11 shows a flowchart illustrating a method for heterogeneous network data path discovery in accordance with aspects of the present disclosure; and

### DETAILED DESCRIPTION

A Social Wi-Fi mesh network may be implemented to support multi-hop communication for a Neighbor Awareness Network (NAN). Social Wi-Fi mesh network may refer to coordinated distribution of data within a group of STAs without utilization of a central AP (e.g., an infrastructure-less network). Accordingly, STAs on the Social Wi-Fi mesh network may share services with one another by establishing an ad-hoc network and routing data from one STA to the next within a certain radius. In some examples, a mesh network may be a full mesh network in which each member station has a connection with every other station on the network. Also, a mesh network may be a partial mesh network in which some member stations may be connected in a full mesh scheme, but other member stations are only connected to one or more of the stations, but not all of the member stations of the network. Further, a social Wi-Fi mesh network may extend the capabilities of a social Wi-Fi framework to enable participating stations to establish mesh connectivity for content delivery.

Mesh networks may be used for static topologies and ad-hoc or neighbor awareness networks. The terms Social Wi-Fi (SWF) and NAN may be used interchangeably herein. A network may comprise a plurality of mesh devices, each of which is capable of relaying data within the network on behalf of other mesh devices in a SWF environment. The data transmitted or routed between the mesh devices may similarly create a data path (DP) wherein the path describes the data flow from one mesh device to another. Accordingly, a Social Wi-Fi Mesh may also be referred to as a NAN data path (NAN DP) or NAN data link (NAN DL), comprising data transferred from a service provider to a service consumer, as described below. As described herein, a mesh may be referred to as a DP, although the two terms may be interchanged.

A NAN DP may include more than one hop. A hop as used herein depends on the number of mesh devices between the device providing the service (e.g., a source device) and the device consuming the service or subscribing to the service (e.g., a destination device) along the DP. For example, a service along a DP that is relayed by one mesh device may be referred to as two hops: source STA to proxy STA (hop one), to destination STA (hop two). While NAN may refer to a subset or network of devices capable of one-hop service discovery, various DPs of a NAN may support service discovery and subscription over multiple hops (multi-hop).

In some examples, a mesh group or a DP group may be used. A DP group may refer to a subset of devices of a NAN cluster that shares a paging window (PW). The DP group may have common security credentials for each of the associated mesh devices, which may serve to restrict membership within the DP. Accordingly, a restricted DP may require out-of-band credentialing. Additionally or alternatively, participating STAs in a DP group may operate on a shared channel or conform to similar channel hoping sequence.

In various examples, a number of factors may contribute to end-to-end latency within a wireless communications system. For example, each component and each interface between components may affect the latency of communications between devices. Thus, routing traffic through multiple devices in a mesh network may impart delay on the end-to-end communication. A hybrid wireless mesh protocol (HWMP), for example, assumes that all devices in a wireless mesh network are configured to operate over a shared network. As a result, traffic in a wireless mesh network may be propagated over a single network (e.g., wireless network). However, modern communications often benefit from, or require, a lower latency operation than may be achievable by transmitting data from the source device to the destination device by traversing multiple network protocols (e.g., wireless or wired network). Therefore, in accordance with aspects of the present disclosure, a participating wireless device with multi-network (e.g., heterogeneous network) capability may aid in establishing a data path between the source device and the destination device that offers, for example, a favorable link metric and/or a minimum or otherwise reduced hop count. In various examples, an improvement of a link metric or a reduction in hop count may be established by routing traffic over a data path that employs a plurality of networks (e.g., two or more of a WLAN, cellular, Long Term Evolution (LTE), or Ethernet network). As compared to a data path employing a single network, establishing a data path that employs a plurality of networks may include improving one or more link metrics such as increasing throughput, reducing packet loss, reducing latency, increasing voice quality, increasing connect rate, or reducing retransmission rate between a source device and a destination device.

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

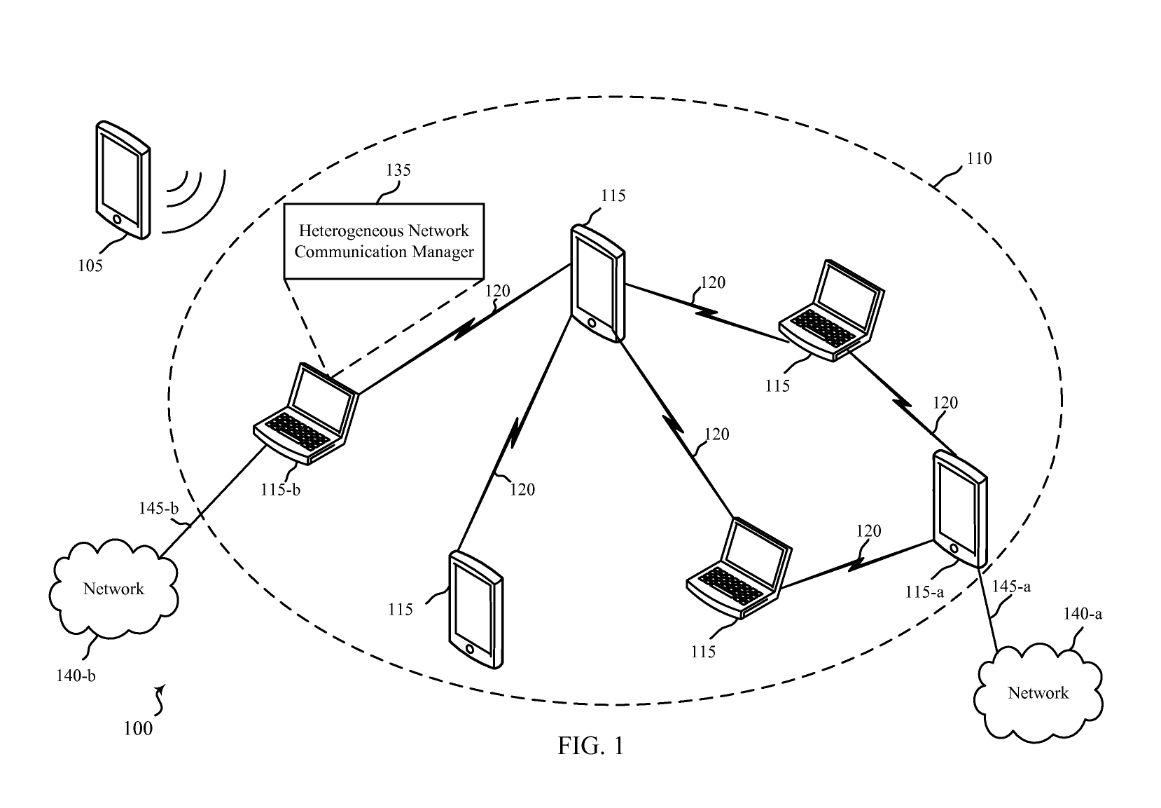

FIG. 1 illustrates a communication system 100 configured for heterogeneous network data path discovery in accordance with aspects of the present disclosure. The communication system 100 includes a mesh network 110. The mesh network 110 may be implemented as a wired or wireless communication network of nodes 115, where each of the nodes may be fixed and/or mobile communication devices, and in some examples may be referred to as stations. In various examples the mesh network 110 may be described as lacking infrastructure, or be referred to as an infrastructure-less network, where the nodes 115 form the mesh network 110 without organizing through an access point, base station, or equipment other than the nodes 115 themselves. In some examples, the mesh network 110 may utilize a data packet routing protocol, such as Hybrid Wireless Mesh Protocol (HWMP) for path determination and/or selection between multiple nodes 115.

The nodes 115 may receive and communicate data throughout the mesh network 110, such as throughout a college campus, metropolitan area, community network, and across other geographic areas. A node 115 may also function to route data from first device (e.g., source device) to a second device (e.g., destination device) within the mesh network 110. In addition, nodes 115 may have more than one communication link to and from other nodes 115 of the mesh network 110, which may provide redundant and/or alternate communication links between a source node 115 and a destination node 115, which in some examples may improve the reliability of the communication system 100.

In some examples, an external communication device 105 may be in proximity of the mesh network 110. The external communication device 105 may join the mesh network 110 by authenticating with one of the nodes 115 of the mesh network 110. In some examples, upon successfully completing a single authentication procedure, the external communication device 105 may receive a group key common to the devices of the mesh network 110 (e.g., nodes 115). The external communication device 105 may use the common group key to discover the topology of the mesh network 110 by sending a route request message to the other nodes 115 and receiving route reply messages. In some examples, such as those where the mesh network 110 is a HWMP network, the route request message and the route reply message may follow aspects of a path request (PREQ) message and path reply (PREP) message, respectively. Based on the received route reply messages, the external communication device 105 may determine a topology of the mesh network 110 and, accordingly, determine a route or path to a source node 115 of the mesh network 110 providing a desired service. As shown in FIG. 1, the mesh network 110 is a partial mesh network, with connections or communication links 120 established between the nodes 115, such that the nodes 115 may communicate with all of the other nodes 115 of the mesh network 110, some directly and some indirectly

The mesh network 110 may be connected to an external network 140-a and an external network 140-b by one or more of the nodes 115 (e.g., nodes 115-a and 115-b) via communication links 145-a or 145-b, respectively. Thus, in accordance with the present disclosure, one or more nodes 115 may be configured for communication using multiple networks, such as multiple networks employing heterogeneous network protocols (e.g., nodes 115-a and 115-b). Nodes 115 configured for communication over multiple networks may be referred to as edge nodes or edge devices, and may include a heterogeneous network communication manager 135. The heterogeneous network communication manager 135 may be configured to perform various functions relating to heterogeneous network path discovery described in reference to the present disclosure.

In various examples the external network(s) 140 may include the Internet, a wide area network (WAN), a wired intranet employing an Ethernet protocol, an LTE network, or any other suitable wired or wireless network employing a network protocol different from the mesh network 110. In some examples, external network 140-a and external network 140-b may refer to the same external network 140, where communication link 145-a represents a first link between the mesh network 110 and the external network 140, and communication link 145-b represents a second link between the mesh network 110 and the external network 140. In various examples, the communication links 145-a or 145-b may be wired or wireless network interfaces. Additionally or alternatively, the external network 140-a or the external network 140-b may be connected via a core network with backhaul communication link (not shown). Additionally, nodes 115-a or 115-b may establish its connection with a base station or access point that has access to the external network(s) 140.

Paths between a first edge device (e.g., node 115-a) and a second edge device (e.g., node 115-b) may be built using route request and/or route reply management messages, which in some examples may be referred to as path request and/or path reply frames. For example, when node 115-a seeks to establish a data path to the node 115-b (e.g., upon seeking to transmit data to the node 115-b), prior to a data path being established between node 115-a and node 115-b, a route request message initiated by the node 115-a may be broadcast throughout the mesh network 110. Intermediate node(s) 115 within the range of the node 115-a may receive the broadcasted route request message and forward the route request message to the destination node 115-b via any number of intermediate device(s) to establish forward DPs. As the route request message is propagated, intermediate node(s) 115 receiving the route request message may create reverse DPs to the node 115-b by transmitting route reply messages. Thus, when the destination node 115-b receives the forwarded route request message, the destination node 115-b may respond with a route reply message, such as a path reply (PREP) message, which may be sent back to the node 115-a via the intermediate node(s) along one or more of the established DPs. The intermediate node(s) may be configured to forward the path reply message back to the source node 115-a based on one or more data path selection algorithms performed by the node 115-b and/or intermediate node(s) 115 along the path. In various examples the path selection algorithm may be configured to select a DP with the optimal link metric (e.g., highest throughput and/or connect rate, or lowest latency and/or packet loss rate), or a most favorable combination of a plurality of link metrics, and/or may select a DP with a lowest number of hops.

In accordance with aspects of the present disclosure, route request messages and subsequent data messages in the communication system 100 may be forwarded or routed from a first node (e.g., node 115-a) to a second node (e.g., node 115-b) via intermediate node(s) 115, where the forwarding steps are commonly referred to as hops in a multi-hop mesh network such as an HWMP network. Additionally or alternatively, one or more nodes 115 may be an edge device configured for multi-network communication (e.g., nodes 115-a and 115-b). Thus, in some examples, a first edge device (e.g., node 115-a) may propagate route request messages and subsequent data messages to a second edge device (e.g., node 115-b) over the external network 140. As a result, the first edge device (e.g., node 115-a) and the second edge device (e.g., node 115-b) may establish a data path that extends beyond the mesh network 110. In one example, the route request message routed over the external network(s) 140 may provide for an established data path having at least one of an improved link metric or a minimized or otherwise reduced hop count between a source node 115 of the mesh network 110 and a destination node 115 of the mesh network 110 as compared with a data path that only uses communication links 120 within the mesh network 110.

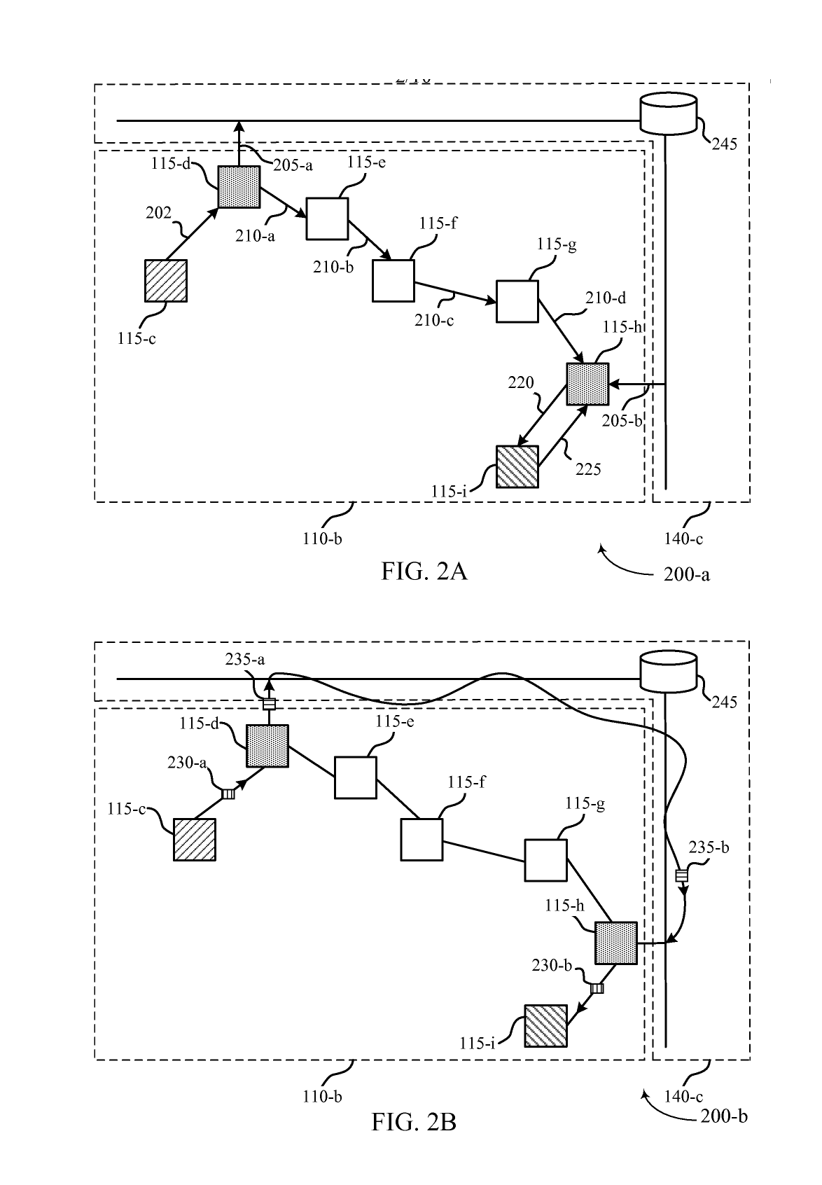

FIGS. 2A and 2B illustrate an example of a communication system 200 configured for heterogeneous network data path discovery in accordance with aspects of the present disclosure. The communication system 200 may include a plurality of nodes 115 (e.g., nodes 115-c through 115-i), which may be examples of nodes 115 described with reference to FIG. 1. The nodes 115 may be part of a mesh network 110-b, which in some examples may be a HWMP network formed by a plurality of wireless communication devices such as STAs. Communication system 200 may also include an external network 140-c, which may be an example of an external network(s) 140 described with reference to FIG. 1, such as a wired Ethernet network.

In accordance with the present disclosure, one or more nodes may be referred to as edge nodes (e.g., first edge node 115-d and second edge node 115-h), where edge nodes are those nodes 115 that are configured to communicate over multiple networks (e.g. both the mesh network 110-b and the external network 140-c). For example, the first node 115-d may communicate over a first network (e.g., mesh network 110-b) with other nodes 115 utilizing a wireless radio. Additionally or alternatively, the first edge node 115-d may be configured to communicate over a second network (e.g., external network 140-c) by utilizing a co-located Ethernet interface. In various examples, the external network 140-c may be a wireless network, wired network, or combination thereof. In some examples, the external network may be associated with an infrastructure device 245, which may be an access point, a base station, a network router, or any other device that provides an infrastructure for the external network 140-c.

Nodes 115 in the mesh network 110-b may share services with one another by establishing an ad-hoc network, which may be an example of an infrastructure-less network. Data can subsequently be routed along a data path from one device to the next within the mesh network 110-b. In examples where a wireless protocol is employed, such as HWMP, a communication link along a data path may be limited to a certain radius, where in various examples the radius may be related to a transmission range and/or reception range of one or more nodes 115, or may be related to otherwise determined distances between nodes 115. Thus, a first device (e.g., a source node 115-c) may transmit a data packet to the second mobile device (e.g., a destination node 115-i) when a data path is established between the source node 115-c and destination node 115-i during a discovery phase. Subsequently, during a data transmission phase, the source node 115-c may transmit data packets to the destination node 115-i over the established data path.

According to aspects of the present disclosure, data paths between the nodes 115 may be built using route request and/or route reply management frames. Thus, with reference to FIG. 2A, the source node 115-c may attempt to establish a data path to the destination node 115-i by broadcasting a message via the mesh network 110-b. In some examples, the route request message may be a PREQ message according to HWMP. Intermediate device(s) (e.g., the first edge node 115-d) within the range of the source node 115-c may receive the route request message over the communication link 202. Upon receiving the route request message, the first edge node 115-d may identify the destination node 115-i based on the destination address provided with the route request message. Therefore, the first edge node 115-d, having access to a first network (e.g., mesh network 110-b) and a second network (e.g., external network 140-c) may determine whether to direct the route request message towards the destination node 115-i via one or both of the first network, the second network, or combination thereof.

Based on the determination, the first edge node 115-d may forward the route request message to the identified destination node 115-i by forwarding the route request message over the mesh network 110-b via the communication links 210, and forwarding the route request message over the external network 140-c via a communication link 205. In some examples, the communication link(s) 210-a through 210-d may be wireless interfaces of the mesh network, such as the wireless interfaces employing HWMP. In some examples, the communication link 205 may be a wired or wireless interface that employs a network protocol other than the mesh network 110-b, which may include a wired or wireless protocol such as the Internet, a wired Ethernet, an LTE network, or any other network protocol.

If the route request message is broadcast over the wireless network over communication links 210, the route request message may propagate though intermediate node(s) 115-e through 115-h prior to reaching the destination node 115-i. At each instance, the intermediate node(s) 115 may increment a hop count associated with the route request message. Thus, a hop count may depend on the number of intermediate nodes 115 between the source node 115-c and the destination node 115-i that the route request message traverses along a respective data path. In the illustrated example, the hop count over the mesh network 110-b may be incremented to six hops based on the intermediate node(s) 115-d through 115-h that the route request message traverses prior to reaching the destination node 115-i.

Additionally or alternatively, the first edge node 115-d may broadcast the route request message over the external network 140-c, including forwarding the route request message over communication link 205-a. In some examples, broadcasting the route request message over the external network 140-c may include the route request message being received, and/or otherwise controlled by the infrastructure device 245 (e.g., a base station, an access point, a network router, etc.). In some examples a data path established by forwarding the route request message between the source node 115-c and the destination node 115-i over the external network 140-c may offer reduced end-to-end latency, increased throughput and/or connect rate, or reduced packet loss between the source node 115-c and the destination node 115-i as compared to a data path within the mesh network 110-b.

In various examples the external network 140-c need not be limited to a wired network protocol, and may be a wireless or a hybrid network utilizing different radio technology and/or a different network protocol than the mesh network 110-b. Thus, the route request message may be propagated over the communication link of the external network 140-c by encapsulating the route request message inside a frame (e.g., an Ethernet frame) having a format associated with the external network 140-c. In some examples, the first edge node 115-d may bridge and forward the route request message from a wireless interface of the mesh network 110-b to a wired interface of the external network 140-c. The frame associated with the external network 140-c may include information (e.g., NAN cluster ID, NAN data link group ID, mesh ID, source MAC and destination MAC) to identify that the source node 115-c and the destination node 115-i are members of the mesh network 110-b.

Additionally or alternatively, the second edge node 115-h may monitor the external network 140-c (e.g., monitor an Ethernet interface) for packets arriving over communication link 205-b. Upon receiving a frame including the forwarded route request message, the second edge node 115-h may identify an address incorporated in the frame that associates the destination node 115-i with the mesh network 110-b. As a result, the second edge node 115-h may extract the route request message from the frame and forward the route request message to the destination node 115-i along the mesh network 110-b via communication link 220.

In some examples, forwarding the route request message over the external network 140-c may establish a path that provides a favorable link metric and/or or minimum hop count (i.e., three hops) as compared to the route request message propagated over the first network (i.e., six hops). Therefore, in some examples the destination node 115-i may determine that a data path along the external network 140-c offers a preferred data path, and may transmit a path reply message towards the source node 115-c. In various examples the route reply message may be transmitted along a data path within the mesh network 110-b, transmitted in a path associated with the reverse of the established data path that includes the external network 140-c (e.g., returning through the second edge node 115-h via reverse link 225 and subsequent reverse links, and/or returning through the first edge node 115-d), or any other path from the destination node 115-i to the source node 115-c. The route reply message may, for example, communicate various aspects of the established data path between the source node 115-c and the destination node 115-i, which may communicate that a portion of the established data path employs the external network 140-c. Various nodes 115 may receive the route reply message, and any node 115 which subsequently receives data to be forwarded to the destination node 115-i may use information in the route reply message to forward the received data to the destination node 115-i along an established data path.

In some examples the destination node 115-i may transmit a plurality of route reply messages in response to receiving the forwarded route request message via a plurality of different data paths, and various devices that receive the route reply messages (e.g., the edge nodes 115-d or 115-h, or the source node 115-c) may establish a data path based at least in part on receiving the plurality of route reply messages. In such examples, devices that subsequently receive data to be forwarded to the destination node 115-i may use information in the plurality of route reply messages to forward the received data to the destination node 115-i along an established data path.

In some examples, determining whether the traffic should be directed via the mesh network 110-b or via the external network 140-c may based on a predetermined characteristic of a data path. For example, the edge node 115-d may forward a route request message via the external network 140-c so that characteristics may be determined about the data path employing heterogeneous networks. However, in some examples the edge node 115-d may not forward the route request message via the mesh network 110-b. Alternatively, the edge node 115-d may rely on predetermined characteristics of the mesh network 110-c, such as a predetermined data path, a predetermined number of hops, a predetermined data rate, or a predetermined latency within the mesh network 110-b between the edge node 115-d and the destination device 115-i. Thus, in some examples the edge node 115-d may determine whether to forward subsequent traffic to the destination node 115-i via the mesh network 110-b or the external network 140-c based on forwarding the route request message via the external network 140-c and the predetermined characteristic of the mesh network. In other examples, the determination may be based at least in part on one or more predetermined characteristics of one or both of the mesh network 110-b or the external network 140-c.

As illustrated in FIG. 2B, the source node 115-c, following an establishment of a data path, may begin transmitting data packets 230 (e.g., data packet 230-a) to the destination node 115-i along an established data path employing both the mesh network 110-b and the external network 140-c. In some examples, the first edge node 115-d may aid the communication by tunneling and forwarding the data packets to the second edge node 115-h inside a frame 235 (e.g., frame 235-a) having a format associated with the external network 140-c (e.g., an Ethernet frame, an LTE frame, etc.). Frames 235 may be forwarded along the established data path, including forwarding through other devices on the external network 140-c (e.g. frame 235-b). Upon receiving a frame 235, the second edge node 115-h may identify an address of the destination node 115-i associated with the frame 235 as being within the mesh network 110-b. Therefore, the second edge node 115-h may extract a data packet 230 from the frame 235 and forward the data packet 230 to the destination node 115-i over the wireless interface along the established path (e.g. data packet 230-b).

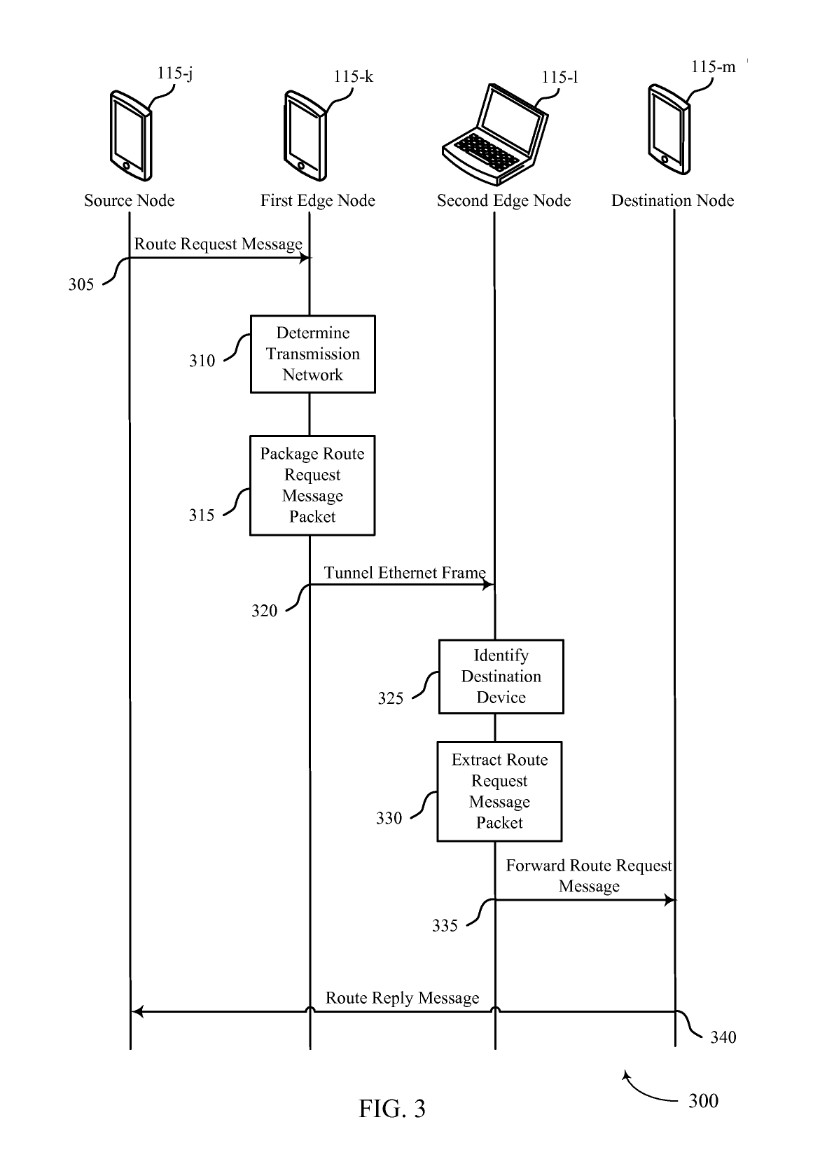

FIG. 3 illustrates an example of a call flow diagram 300 for heterogeneous network data path discovery in accordance with aspects of the present disclosure. The call flow diagram 300 may include a plurality of nodes(s) 115, which may be examples of nodes 115 described with reference to FIGS. 1-2. In one example, the call flow diagram 300 may include a source node 115-j, a first edge node 115-k, a second edge node 115-1 and a destination node 115-m. In various examples the source node 115-j and the destination node may be members of a first network, which may be a mesh network such as a HWMP network. First edge node 115-k and second edge node 115-1 may be configured to communicate over the first network, and may also be configured to communicate over a second network employing a different protocol, such as a wired Ethernet protocol. It should be understood that the second network is not limited to the wired network and may be a wireless network different from the first network.

In accordance with aspects of the present disclosure, the source node 115-j may transmit a route request message 305 to the edge node 115-k. In one or more examples, the route request message 305 may traverse over multiple nodes of the first network prior to being received by the first edge node 115-k. Upon receiving the route request message 305, the first edge node 115-k, at block 310, may determine whether to transmit the route request message directed towards the destination node 115-m via one or both of the first network or the second network. In some examples the edge node 115-k may be configured for multi-network connectivity.

Based on the determination, the first edge node 115-k may decide to forward the route request message 305 towards the destination node 115-m via the second network, wherein the second network employs a different protocol from the first network. In order to facilitate the forwarding, the first edge node 115-k, at block 315, may encapsulate the packet inside a frame having a format associated with the second network. In some examples, the format associated with the second network may be an Ethernet frame format. Accordingly, at block 320, the first edge node 115-k may tunnel a packaged Ethernet frame to the second edge node 115-1 over the second network.

In some examples, the second edge node 115-1 may actively monitor an interface associated with the first network and an interface associated with the second network for packages transmitted over the respective networks. Upon detecting the reception of the tunneled Ethernet frame over the interface associated with the second network, the second edge node 115-1, at block 325, may identify the destination node 115-m based on the destination address attached to the Ethernet frame. In one or more examples, the frame may identify an address of the destination node 115-m, which may be associated with the first network. In some examples the first network may be a HWMP network of which both the source node 115-j and the destination node 115—are members. In some examples, the frame may comprise at least one of a NAN cluster identification, a NAN data link group ID, a mesh ID, source media access control (MAC) address or a destination MAC address. Thus, the second edge node 115-1 may determine whether the intended destination device is within the first network based on the received frame.

If the second edge node 115-1 determines that the destination node 115-m is a member of the first network, the second edge node 115-1, at block 330, may extract the route request message 305 from the received frame. In examples where the first network is a HWMP network, block 330 may include extracting a packet formatted according to a hybrid wireless mesh protocol. The extracted route request message may then, at block 335, be forwarded to the destination node 115-m.

In some examples, upon receiving the forwarded route request message, the destination node 115-m may transmit a route reply message 340 to the source node 115-k. In various examples the route reply message may be transmitted along a data path within the first network, transmitted in a path associated with the reverse of the established data path that includes the external network 140-c (e.g., returning through the second edge node 115-1 and/or the first edge node 115-k), or any other path from the destination node 115-m to the source node 115-j. The route reply message may, for example, communicate various aspects of a data path established by the destination node 115-m between the source node 115-c and the destination node 115-h, which may a portion of the established data path employing the second network. In other examples the destination node 115-m may transmit a plurality of route reply messages in response to receiving the forwarded route request message via a plurality of different data paths, and various devices that receive the route reply messages (e.g., the source node 115-j) may establish a data path based at least in part on receiving the plurality of route reply messages.

As a result of the described steps of the call flow diagram 300, a data path between the source node 115-j and the destination node 115-m may be established based at least in part on a route request message being forwarded along a data path employing a plurality of heterogeneous networks. In some examples, as compared to a data path within a single network, the data path being established across a plurality of heterogeneous networks may offer an improved link metric and/or a reduced hop count between the source node 115-j and the destination node 115-m.

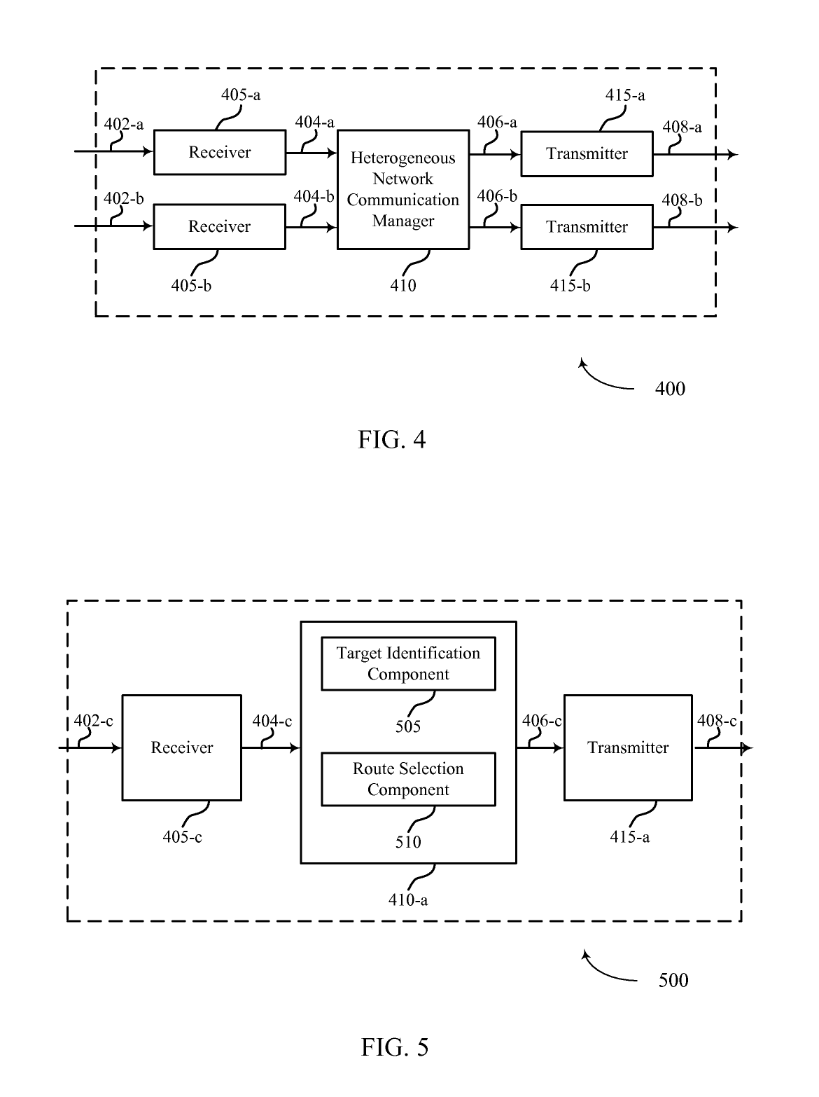

FIG. 4 shows a block diagram of a communication device 400 configured for heterogeneous network data path discovery in accordance with aspects of the present disclosure. Communication device 400 may be an example of aspects of nodes 115 described with reference to FIGS. 1, 2A, 2B, and 3. In some examples communication device 400 may be an example of aspects of edge nodes 115 described with reference to FIGS. 1, 2A, 2B, and 3, and the communication device 400 may be configured for communications via a first network and communications via a second network. Communication device 400 may include a first receiver 405-a, second receiver 405-b, a heterogeneous network communication manager 410, a first transmitter 415-a, or a second transmitter 415-b. Heterogeneous network communication manager 410 may be an example of aspects of heterogeneous network communication manager 135 described with reference to FIG. 1. Communication device 400 may also include a processor. Each of these components may be in communication with each other.

The components of communication device 400 may, individually or collectively, be implemented with at least one application specific integrated circuit (ASIC) adapted to perform some or all of the applicable functions in hardware. Alternatively, the functions may be performed by one or more other processing units (or cores), on at least one integrated circuit (IC). In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The first receiver 405-a and the second receiver 405-b may each receive information such as packets, user data, or control information associated with various information channels (e.g., control channels, data channels, and information related to network routing, such as heterogeneous network data path discovery, etc.) over communication links 402-a and 402-b, respectively. In some examples, the first receiver 405-a may be configured to receive information from a first network, and the second receiver 405-b may be configured to receive information via a second network that employs a network protocol different from the first network. Accordingly, communication links 402-a and 402-b may employ different protocols, and each may be associated with a wired or wireless network protocol.

Information may be passed on to the heterogeneous network communication manager 410 via a first communication link 404-a and/or a second communication link 404-b, and to other components of communication device 400. In some examples, the first receiver 405-a or the second receiver 405-b may receive a route request message (e.g., PREQ message) from a source device over a first network, or receive an encapsulated route request message from another edge device over a second network. In other examples, the first receiver 405-a or the second receiver 405-b may receive a data packet from the source device via a first network, or receive an encapsulated data packet from another edge device via a second network. Although the first receiver 405-a and the second receiver 405-b are shown as separate receivers, in some examples the first receiver 405-a and the second receiver 405-b may form a single receiver module or receiver assembly. Accordingly, information may be passed over a single communication link 404.

In accordance with the present disclosure, the receiver(s) 405 may forward received information to the heterogeneous network communication manager 410. For example, the heterogeneous network communication manager 410 may receive a route request message from a source device over a first network, and identify a destination device within the first network based at least in part on the route request message. In some examples the heterogeneous network communication manager may extract the route request message from a frame having a format associated with a particular network protocol. In some examples the heterogeneous network communication manager may determine whether to forward the route request message towards the destination device via one or both of the first network or via a second network. In some examples, the heterogeneous network communication manager 410 may be configured to forward a route request message and/or subsequent data packets to the transmitter 415 over one or more communication link(s) 406. In various examples, the heterogeneous network communication manager may encapsulate a route request message and/or subsequent data prior to transmission, which may include tunneling a packet inside a frame having a format associated with a particular network protocol. In some examples the heterogeneous network communication manager 410 may be configured to receive an encapsulated route request message or subsequent data that was transmitted over the second network, and extract the route request message and/or subsequent data prior to forwarding over the first network.

The first transmitter 415-a and the second transmitter 415-b may each transmit signals received from other components of communication device 400. In some embodiments, the first transmitter 415-a and/or the second transmitter 415-b may be collocated with one or both of the first receiver 405-a or the second receiver 405-b in one or more transceiver(s). The first transmitter 415-a and the second transmitter 415-b may each include a single antenna, or they may include a plurality of antennas. In some examples, the first transmitter 415-a or the second transmitter 415-b may transmit an encapsulated route request message or encapsulated data packets to an identified destination device via a second network based at least in part on the determining by propagating the message over first communication link 408-a or second communication link 408-b, respectively. In some examples the first transmitter 415-a or the second transmitter 415-b may forward a route request message or data packets to a destination node via a first network.

FIG. 5 shows a block diagram of a communication device 500 configured for heterogeneous network data path discovery in accordance with aspects of the present disclosure. Communication device 500 may be an example of aspects of a communication device 400 described with reference to FIG. 4 or a node 115 described with reference to FIG. 1, 2A, 2B, or 3. In some examples communication device 500 may be an example of aspects of edge nodes 115 described with reference to FIGS. 1, 2A, 2B, and 3, and the communication device 400 may be configured for communications via a first network and communications via a second network. Communication device 500 may include a receiver 405-a, a heterogeneous network communication manager 410-a, or a transmitter 415-a. Communication device 500 may also include a processor. Although shown as having a single receiver 405-c and a single transmitter 415-c, in some examples the communication device 500 may have more than one receiver and/or transmitter, such as receivers 405-a and 405-b and transmitters 415-a and 415-b of communication device 400 described with reference to FIG. 4. Heterogeneous network communication manager 410-a may be an example of aspects of heterogeneous network communication managers 135 or 410 described with reference to FIG. 1 or 4. The heterogeneous network communication manager 410-a may also include a target identification component 505, and a route selection component 510. Each of these components may be in communication with each other.

The components of communication device 500 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 405-a may receive information via communication link 402-a which may be passed on to heterogeneous network communication manager 410-a via communication link 404-a, and to other components of communication device 500. The heterogeneous network communication manager 410-a may perform the operations described with reference to FIG. 4. The transmitter 415-a man transmit signals received from other components of communication device 500.

The target identification component 505 may identify a destination device within a first network based at least in part on a route request message as described with reference to FIGS. 1, 2A, 2B, and/or 3. In some examples the target identification component 505 may identify a destination device address based on a frame received via a second network, where the frame may include a route request message or data intended for the destination device. In some examples, the destination device address may be included in a route request message or a frame received at the target identification component 505.

In accordance with the present disclosure, the route selection component 510 may determine whether to forward a route request message or subsequent data directed towards the destination device via the first network or via a second network as described with reference to FIGS. 1, 2A, 2B, and/or 3. In some examples the first network may be a mesh network such as a HWMP network, and in some examples the second network may be a wired network such as a wired Ethernet network. It should be noted that second network is not limited to a wired network, and thus may include a wireless network or a hybrid network comprising a wireless and wired network.

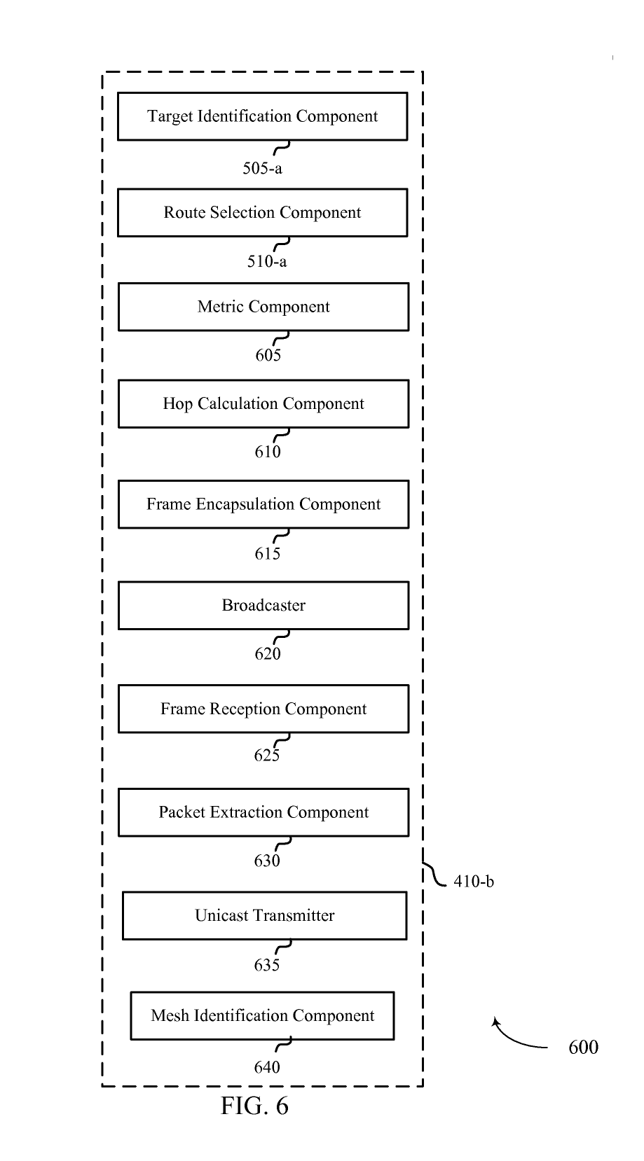

FIG. 6 shows a block diagram 600 of a heterogeneous network communication manager 410-b, which may be a component of a communication device 400 or a communication device 500, configured for heterogeneous network data path discovery in accordance with aspects of the present disclosure. The heterogeneous network communication manager 410-b may be an example of aspects of a heterogeneous network communication managers 135 or 410 described with reference to FIGS. 1, 4, and 5. The heterogeneous network communication manager 410-b may include a target identification component 505-a, and a route selection component 510-a. Each of these modules may perform the functions described with reference to FIG. 5. The heterogeneous network communication manager 410-b may also include a metric component 605, a hop calculation component 610, a frame encapsulation component 615, a broadcaster 620, a frame reception component 625, a packet extraction component 630, an unicast transmitter 635, and a mesh identification component 640.

The components of the heterogeneous network communication manager 410-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The metric component 605 may be configured to monitor and/or calculate link metrics based at least in part on forwarding a route request message such that an established data path provides at least one of a favorable link metric, or minimum hop count, or a combination thereof between the source device and the destination device as described with reference to FIG. 1, 2A, 2B, or 3. For example, the metric component 605 may identify a data path having a highest throughput, a highest connect rate, a highest voice quality, a lowest packet loss, or a lowest latency. In some examples the metric component may identify a data path having a most favorable combination of link metrics, which may be an algorithm that combines, for example, connect rate, throughput, latency, and packet loss into a single metric. In some examples, the metric component 605 may monitor and/or calculate link metrics for a data path that includes a network other than a network that a source device and a destination device are members of. The hop calculation component 610 may increment a hop count based on forwarding a route request message and/or or subsequent over the second network as described with reference to FIG. 1, 2A, 2B, or 3.

The frame encapsulation component 615 may be configured such that forwarding a route request message to the destination device via the second network may include tunneling a packet comprising the route request message inside a frame having a format associated with a protocol of the second network as described with reference to FIG. 1, 2A, 2B, or 3. In some examples, the frame may be formatted according to a hybrid wireless mesh protocol. In some examples, the frame includes an identification that the source device and the destination device are within or are otherwise members of a first network. In some examples, the frame comprises at least one of a NAN cluster ID, a NAN data link group ID, a mesh ID, a source MAC address or a destination MAC address. The frame encapsulation component 615 may also encapsulate the data packet inside a frame having a format associated with a protocol of the second network.

The broadcaster 620 may broadcast the frame including the route request message over a second network as described with reference to FIG. 1, 2A, 2B, or 3. The frame reception component 625 may receive a frame via the second network comprising a packet as described with reference to FIG. 1, 2A, 2B, or 3. The frame reception component 625 may also receive a frame having a format associated with a protocol of the second network.

The packet extraction component 630 may extract the packet, which may be an example of a HWMP packet, from the frame as described with reference to FIG. 1, 2A, 2B, or 3. The packet extraction component 630 may also extract a data packet from a frame based on the determining that the destination device is within the first network.

The unicast transmitter 635 may forward the packet to the destination device via the first network as described with reference to FIGS. 2-3. In some examples this may include forwarding a HWMP packet over a mesh network. The unicast transmitter 635 may also transmit the frame to the destination device along an established data path, wherein the established data path is based at least in part on a forwarded route request message, and traverses the second network. The unicast transmitter 635 may also forward a data packet to the destination device along the established data path.

The mesh identification component 640 may determine that the destination device is within the first network based on the destination device address as described with reference to FIGS. 2-3. In some examples, the mesh identification component may identify a destination within a HWMP network.

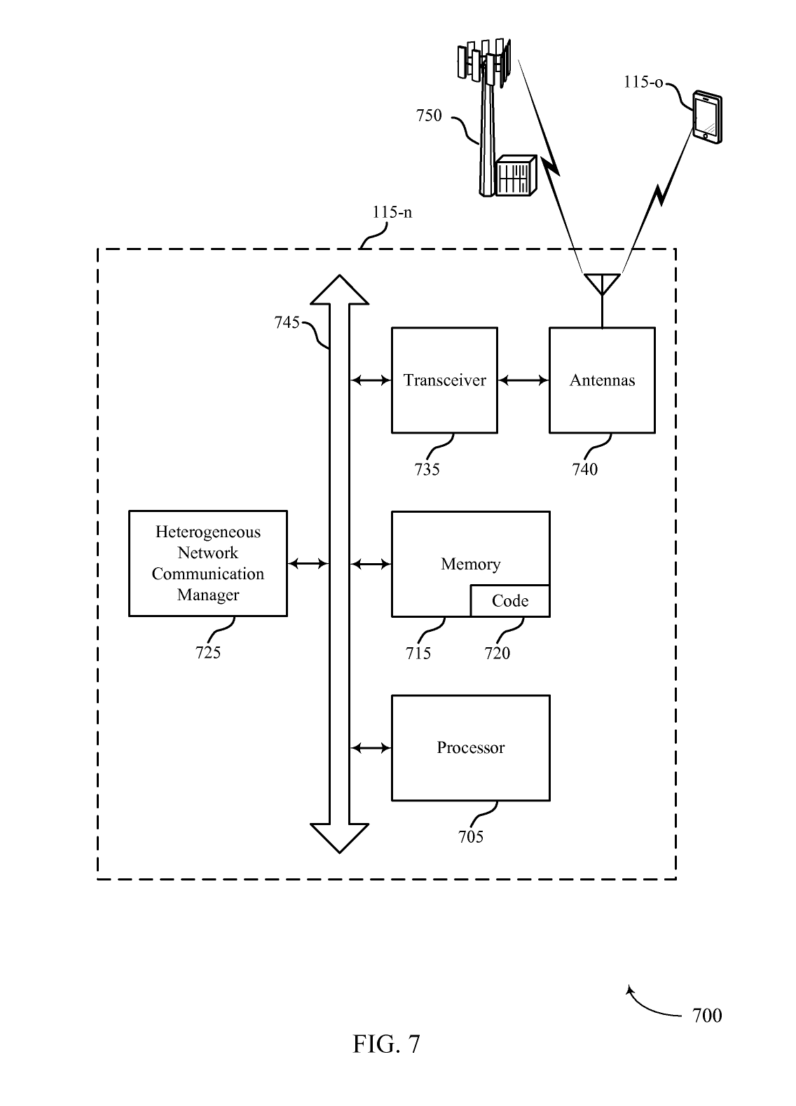

FIG. 7 illustrates a block diagram of a system 700 including a node 115-n configured for heterogeneous network data path discovery in accordance with aspects of the present disclosure. Node 115-n may be an example of aspects of a communication device 400 or 500 described with reference to FIG. 4 or 5, or a node 115 described with reference to FIG. 1, 2A, 2B, or 3. Node 115-n may include a heterogeneous network communication manager 725, which may be an example of aspects of heterogeneous network communication managers 410 described with reference to FIG. 4, 5, or 6. Node 115-n may also include components for bi-directional voice and data communications including components for transmitting communications and components for receiving communications. For example, node 115-n may communicate bi-directionally with an AP 750 or another node 115-o, where such communications may be wired (not shown) or wireless communications, and may include communication over multiple networks employing more than one network protocol.

The heterogeneous network communication manager 725 may configure the node 115-n to operate over multiple networks simultaneously as described with reference to FIG. 1, 2A, 2B, or 3. Node 115-n may also include a processor 705, and memory 715 (including software/firmware code 720), a transceiver 735, and one or more antenna(s) 740, each of which may communicate, directly or indirectly, with one another (e.g., via buses 745). The transceiver 735 may communicate bi-directionally, via the antenna(s) 740 or wired or wireless links, with one or more networks, as described. For example, the transceiver 735 may communicate bi-directionally with a AP 750 or another node 115. The transceiver 735 may include a modem to modulate the packets and provide the modulated packets to the antenna(s) 740 for transmission, and to demodulate packets received from the antenna(s) 740. While node 115-n may include a single antenna 740, node 115-n may also have multiple antennas 740 capable of concurrently transmitting or receiving multiple wireless transmissions.

The memory 715 may include random access memory (RAM) and read only memory (ROM). The memory 715 may store computer-readable, computer-executable software/firmware code 720 including instructions that, when executed, cause the processor 705 to perform various functions described herein (e.g., heterogeneous hybrid wireless mesh protocol routing, etc.). Alternatively, the software/firmware code 720 may not be directly executable by the processor 705 but cause a computer (e.g., when compiled and executed) to perform functions described herein. The processor 705 may include an intelligent hardware device, (e.g., a central processing unit (CPU), a microcontroller, an ASIC, etc.)

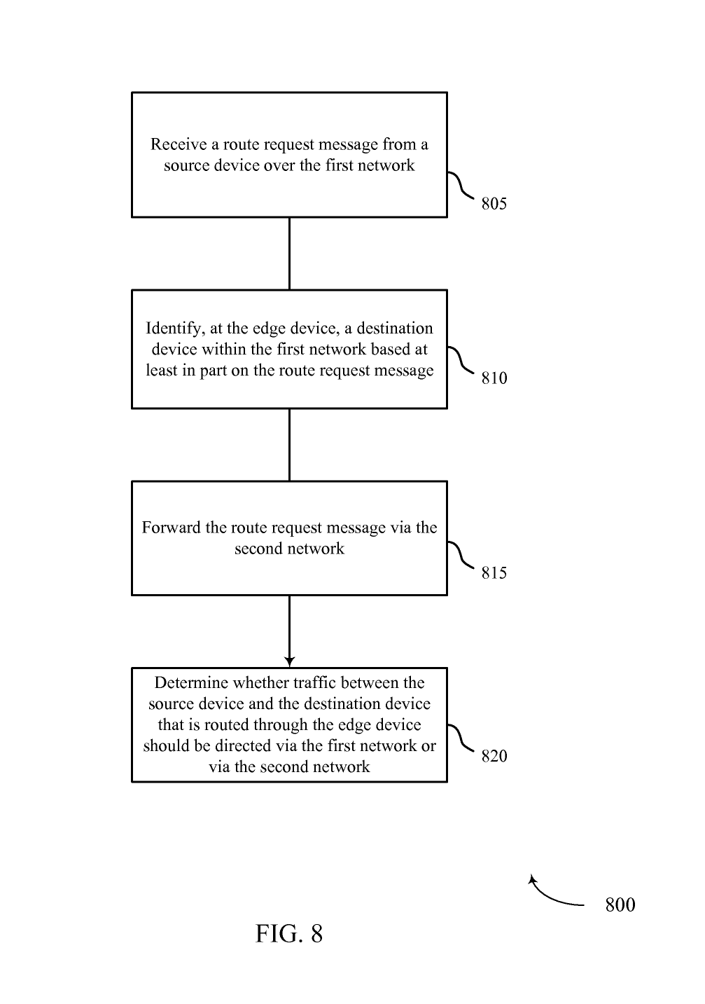

FIG. 8 shows a flowchart illustrating a method 800 for heterogeneous network data path discovery in accordance with aspects of the present disclosure. The operations of method 800 may be implemented by various components of a node 115 or a communication device 400 or 500 as described with reference to FIGS. 1-7. In some examples, the node 115 may be an edge node (e.g., an edge device) configured for communication over more than one network, wherein the networks may employ heterogeneous network protocols. For example, operations of method 800 may be performed by a heterogeneous network communication manager 135, 410, or 725 as described with reference to FIG. 1, 4, 5, 6, or 7. In some examples, a node 115 may execute a set of codes to control the functional elements of the node 115 to perform the functions described below. Additionally or alternatively, the node 115 may perform aspects the functions described below using special-purpose hardware.

At block 805, the node 115 may receive a route request message from a source device over a first network, as described with reference to FIG. 1, 2A, 2B, or 3. In some examples, the operations of block 805 may be performed by a receiver 405 as described with reference to FIG. 4 or 5, or antenna(s) 740 or transceiver 735 described with reference to FIG. 7.

At block 810, the node 115 may identify a destination device within the first network based at least in part on the route request message, as described with reference to FIG. 1, 2A, 2B, or 3. In some examples, the operations of block 810 may be performed by a portion of a heterogeneous network communication manager, such as one of the target identification components 505 as described with reference to FIG. 5 or 6.

At block 815, the node 115 may forward the route request message via the second network, as described with reference to FIG. 1, 2A, 2B, or 3. In some examples, forwarding the route request message may include broadcasting a frame via the second network, wherein the broadcasting may include tunneling a packet having a format associated with a protocol of the first network inside a frame having a format associated with a protocol of the second network. For example, at block 815 the node may encapsulate a HWMP packet may in an Ethernet frame for broadcast over the second network. In some examples, the operations of block 815 may be performed by a transmitter 415 as described with reference to FIG. 4 or 5, or antenna(s) 740 or transceiver 735 described with reference to FIG. 7.

At block 820, the node 115 may determine whether traffic between the source device and the destination device that is routed through the node 115 should be directed via the first network or via the second network, as described with reference to FIG. 1, 2A, 2B, or 3. In some examples, the operations of block 820 may be performed by a portion of a heterogeneous network communication manager, such as one of the route selection components 510 as described with reference to FIG. 5 or 6.

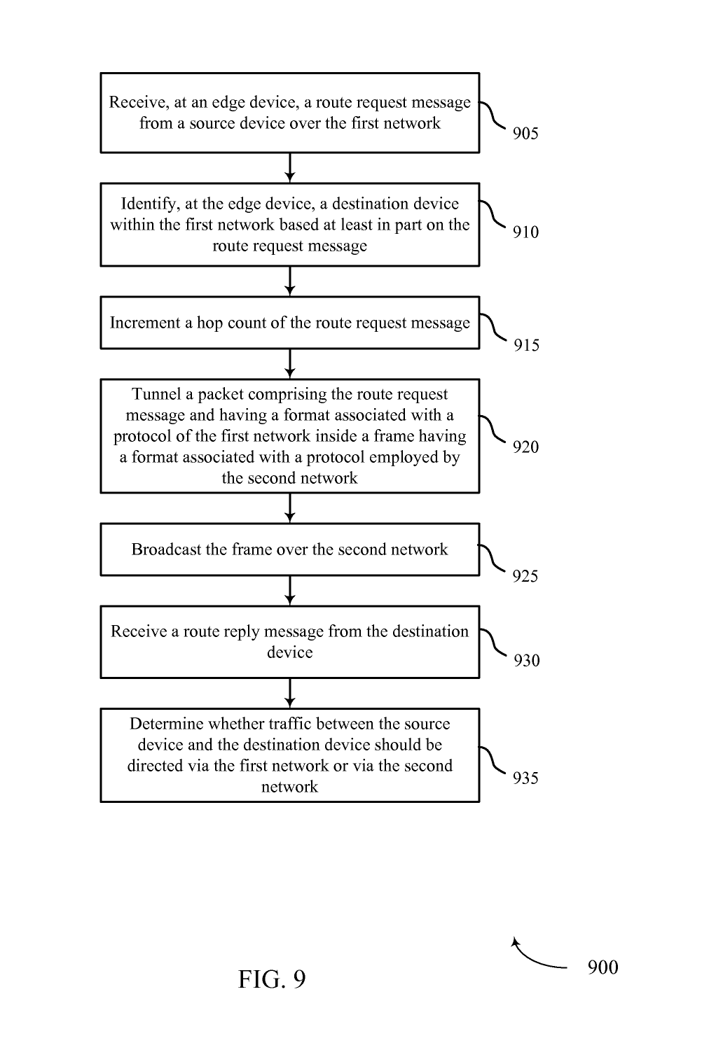

FIG. 9 shows a flowchart illustrating a method 900 for heterogeneous network data path discovery in accordance with aspects of the present disclosure. The operations of method 900 may be implemented by various components of a node 115 or a communication device 400 or 500 as described with reference to FIGS. 1-7. In some examples, the node 115 may be an edge node (e.g., an edge device) configured for communication over more than one network, wherein the networks may employ heterogeneous network protocols. For example, operations of method 900 may be performed by a heterogeneous network communication manager 135, 410, or 725 as described with reference to FIG. 1, 4, 5, 6, or 7. In some examples, a node 115 may execute a set of codes to control the functional elements of the node 115 to perform the functions described below. Additionally or alternatively, the node 115 may perform aspects the functions described below using special-purpose hardware.

At block 905, the node 115 may receive a route request message from a source device over a first network, as described with reference to FIG. 1, 2A, 2B, or 3. In some examples, the operations of block 905 may be performed by a receiver 405 as described with reference to FIG. 4 or 5, or antenna(s) 740 or transceiver 735 described with reference to FIG. 7.

At block 910, the node 115 may identify a destination device within the first network based at least in part on the route request message, as described with reference to FIG. 1, 2A, 2B, or 3. In some examples, the operations of block 910 may be performed by a portion of a heterogeneous network communication manager, such as one of the target identification components 505 as described with reference to FIG. 5 or 6.

At block 915, the node 115 may increment a hop count of the route request message, as described with reference to FIG. 1, 2A, 2B, or 3. In some examples, the operations of block 915 may be performed by a portion of a heterogeneous network communication manager, such as the hop calculation component 610 described with reference to FIG. 6.

At block 920, the node 115 may tunnel a packet comprising the route request message and having a format associated with a protocol of the first network inside a frame having a format associated with a protocol of the second network, as described with reference to FIG. 1, 2A, 2B, or 3. For example, at block 920 the node may encapsulate a HWMP packet in an Ethernet frame. In some examples, the operations of block 920 may be performed by a portion of a heterogeneous network communication manager, such as the frame encapsulation component 615 as described with reference to FIG. 6.

At block 925, the node 115 may broadcast the frame over the second network. In some examples, the operations of block 925 may be performed by a transmitter 415, as described with reference to FIG. 4 or 5, or antenna(s) 740 or transceiver 735 described with reference to FIG. 7.

At block 930, the node 115 may receive a route reply message from the destination device. In some examples, the operations of block 930 may be performed by a receiver 405, as described with reference to FIG. 4 or 5, or antenna(s) 740 or transceiver 735 described with reference to FIG. 7.

At block 935, the node 115 may determine whether traffic between the source device and the destination device that is routed through the node 115 should be directed via the first network or via the second network as described with reference to FIG. 1, 2A, 2B, or 3. The determination may be based on one or both of the forwarded route request message or the received route reply message. In some examples, the operations of block 935 may be performed by a portion of a heterogeneous network communication manager, such as one of the route selection components 510 as described with reference to FIG. 5 or 6.

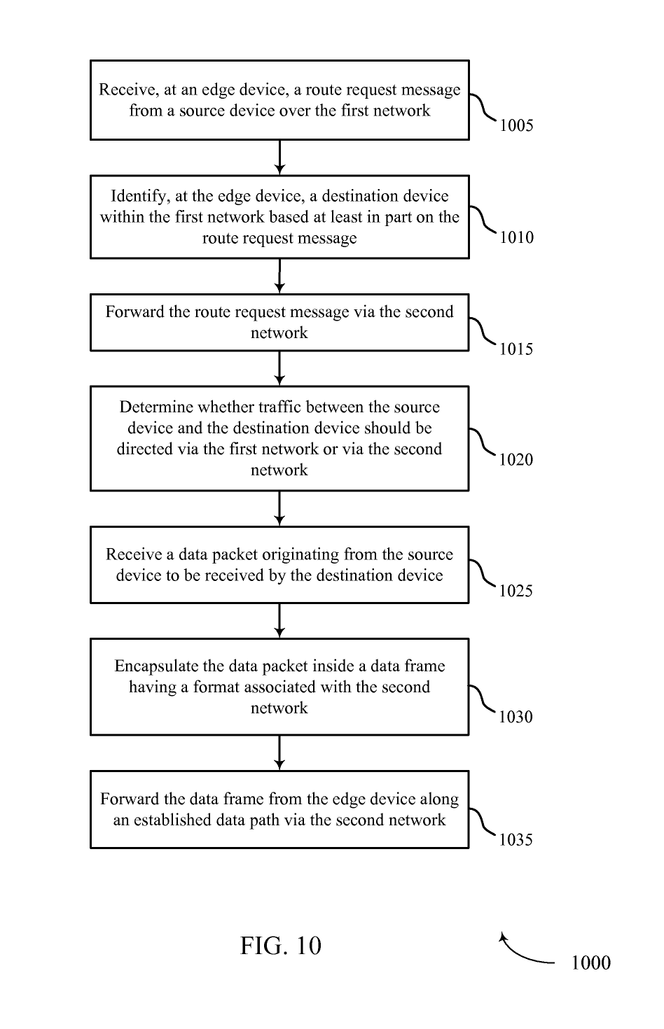

FIG. 10 shows a flowchart illustrating a method 1000 for heterogeneous network data path discovery in accordance with aspects of the present disclosure. The operations of method 1000 may be implemented by various components of a node 115 or a communication device 400 or 500 as described with reference to FIGS. 1-7. In some examples, the node 115 may be an edge node (e.g., an edge device) configured for communication over more than one network, wherein the networks may employ heterogeneous network protocols. For example, operations of method 1000 may be performed by a heterogeneous network communication manager 135, 410, or 725 as described with reference to FIG. 1, 4, 5, 6, or 7. In some examples, a node 115 may execute a set of codes to control the functional elements of the node 115 to perform the functions described below. Additionally or alternatively, the node 115 may perform aspects the functions described below using special-purpose hardware.

At block 1005, the node 115 may receive a route request message from a source device over a first network, as described with reference to FIG. 1, 2A, 2B, or 3. In some examples, the operations of block 1005 may be performed by a receiver 405 as described with reference to FIG. 4 or 5, or antenna(s) 740 or transceiver 735 described with reference to FIG. 7.

At block 1010, the node 115 may identify a destination device within the first network based at least in part on the route request message, as described with reference to FIG. 1, 2A, 2B, or 3. In some examples, the operations of block 1010 may be performed by a portion of a heterogeneous network communication manager, such as one of the target identification components 505 as described with reference to FIG. 5 or 6.

At block 1015, the node 115 may forward the route request message via the second network, as described with reference to FIG. 1, 2A, 2B, or 3. In some examples, forwarding the route request message may include broadcasting a frame via the second network, wherein the broadcasting may include tunneling a packet having a format associated with a protocol of the first network inside a frame having a format associated with a protocol of the second network. For example, at block 1015 the node may encapsulate a HWMP packet may in an Ethernet frame for broadcast over the second network. In some examples, the operations of block 1015 may be performed by a transmitter 415 as described with reference to FIG. 4 or 5, or antenna(s) 740 or transceiver 735 described with reference to FIG. 7.

At block 1020, the node 115 may determine whether traffic between the source device and the destination device that is routed through the node 115 should be directed via the first network or via the second network, as described with reference to FIG. 1, 2A, 2B, or 3. In some examples, the operations of block 1020 may be performed by a portion of a heterogeneous network communication manager, such as one of the route selection components 510 as described with reference to FIG. 5 or 6.

At block 1025, the node 115 may receive a data packet originating from the source device to be received by the destination device, as described with reference to FIG. 1, 2A, 2B, or 3. In some examples, the operations of block 1025 may be performed by a receiver 405 as described with reference to FIG. 4 or 5, or antenna(s) 740 or transceiver 735 described with reference to FIG. 7.

At block 1030, the node 115 may encapsulate the data packet inside a data frame having a format associated with a protocol of the second network, as described with reference to FIG. 1, 2A, 2B, or 3. For example, at block 1030 the node may encapsulate a HWMP packet in an Ethernet frame. In some examples, the operations of block 1030 may be performed by a portion of a heterogeneous network communication manager, such as the frame encapsulation component 615 as described with reference to FIG. 6.

At block 1035, the node 115 may forward the data frame along an established data path via the second network, as described with reference to FIG. 1, 2A, 2B, or 3. The established data path may be based on, for example, determining whether traffic between the source device and the destination device should be directed via the first network or via the second network. In some examples, the operations of block 1035 may be performed by a transmitter 415 as described with reference to FIG. 4 or 5, or antenna(s) 740 or transceiver 735 described with reference to FIG. 7.

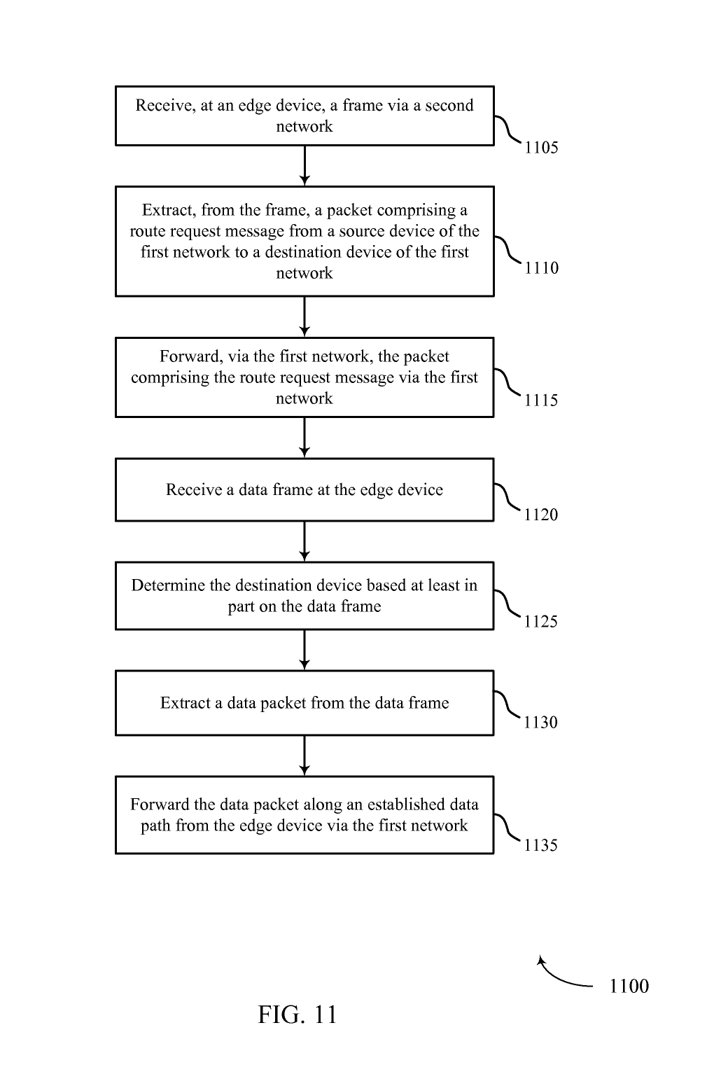

FIG. 11 shows a flowchart illustrating a method 1100 for heterogeneous network data path discovery in accordance with aspects of the present disclosure. The operations of method 1100 may be implemented by various components of a node 115 or a communication device 400 or 500 as described with reference to FIGS. 1-7. In some examples, the node 115 may be an edge node (e.g., an edge device) configured for communication over more than one network, wherein the networks may employ heterogeneous network protocols. For example, operations of method 1100 may be performed by a heterogeneous network communication manager 135, 410, or 725 as described with reference to FIG. 1, 4, 5, 6, or 7. In some examples, a node 115 may execute a set of codes to control the functional elements of the node 115 to perform the functions described below. Additionally or alternatively, the node 115 may perform aspects the functions described below using special-purpose hardware.

At block 1105, the node 115 may receive a frame via a second network, as described with reference to FIG. 1, 2A, 2B, or 3. In some examples, the operations of block 1105 may be performed by a receiver 405 as described with reference to FIG. 4 or 5, or antenna(s) 740 or transceiver 735 described with reference to FIG. 7.

At block 1110, the node 115 may extract, from the frame, a packet comprising a route request message from a source device of the first network to a destination device of the first network, as described with reference to FIG. 1, 2A, 2B, or 3. In some examples, the operations of block 1110 may be performed by a portion of a heterogeneous network communication manager, such as the packet extraction component 630 as described with reference to FIG. 6.

At block 1115, the node 115 may forward, via the first network, the packet comprising the route request message, as described with reference to FIG. 1, 2A, 2B, or 3. In some examples, the operations of block 1115 may be performed by a transmitter 415 as described with reference to FIG. 4 or 5, or antenna(s) 740 or transceiver 735 described with reference to FIG. 7.

At block 1120, the node 115 may receive a data frame, as described with reference to FIG. 1, 2A, 2B, or 3. In some examples, the operations of block 1120 may be performed by a receiver 405 as described with reference to FIG. 4 or 5, or antenna(s) 740 or transceiver 735 described with reference to FIG. 7.

At block 1125, the node 115 may determine the destination device based at least in part on the data frame, as described with reference to FIG. 1, 2A, 2B, or 3. In some examples, the operations of block 1125 may be performed by a portion of a heterogeneous network communication manager, such as one of the target identification components 505 as described with reference to FIG. 5 or 6.

At block 1130, the node 115 may extract a data packet from the data frame, as described with reference to FIG. 1, 2A, 2B, or 3. For example, at block 1030 the node may extract a HWMP packet from an Ethernet frame. In some examples, the operations of block 1130 may be performed by a portion of a heterogeneous network communication manager, such as the packet extraction component 630 as described with reference to FIG. 6.

At block 1135, the node 115 may forward the data packet along an established data path via the first network, as described with reference to FIG. 1, 2A, 2B, or 3. The established data path may be based on, for example, determining whether traffic between the source device and the destination device should be directed via the first network or via the second network. In some examples, the operations of block 1135 may be performed by a transmitter 415 as described with reference to FIG. 4 or 5, or antenna(s) 740 or transceiver 735 described with reference to FIG. 7.

Thus, methods 800, 900, 1000, and 1100 may provide for heterogeneous network data path discovery. It should be noted that methods 800, 900, 1000, and 1100 describe possible implementation, and that the operations and the steps may be rearranged or otherwise modified such that other implementations are possible. In some examples, aspects from two or more of the methods 800, 900, 1000, and 1100 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of communication networking, comprising:
receiving, at an edge device connected to a first network and a second network, a route request message from a source device via the first network;
identifying, at the edge device, a destination device within the first network based at least in part on the route request message;
forwarding the route request message via the second network; and
determining, based at least in part on the forwarded route request message, whether traffic between the source device and the destination device that is routed through the edge device should be directed via the first network or via the second network.

2. The method of claim 1, wherein the determining comprises:
receiving a route reply message from the destination device, the route reply message based at least in part on the forwarded route request message.

3. The method of claim 1, wherein the determining comprises:
determining, based at least in part on the forwarded route request message, that a data path via the second network provides at least one of a favorable link metric, or minimum hop count, or a combination thereof between the source device and the destination device as compared to a data path via the first network.

4. The method of claim 1, wherein forwarding the route request message via the second network comprises:
incrementing a hop count of the route request message.

5. The method of claim 1, wherein forwarding the route request message via the second network comprises:
tunneling a packet comprising the route request message and having a format associated with a protocol employed by the first network inside a frame having a format associated with a protocol employed by the second network; and
broadcasting the frame over the second network.

6. The method of claim 5, wherein the frame comprises an identification that the source device and the destination device are within the first network.

7. The method of claim 5, wherein the frame comprises at least one of a neighbor awareness network (NAN) cluster identification (ID), a NAN data link group ID, a mesh ID, a medium access control (MAC) address of the source device, or a MAC address of the destination device.

8. The method of claim 1, wherein determining whether the traffic should be directed via the first network or via the second network is based at least in part on one or both of: a predetermined characteristic of a data path from the edge device to the destination device via the first network, or a predetermined characteristic of a data path from the edge device to the destination device via the second network.

9. The method of claim 1, further comprising:
receiving, at the edge device, a data packet originating from the source device to be received by the destination device;
encapsulating the data packet inside a data frame having a format associated with the second network; and
forwarding the data frame from the edge device along an established data path via the second network, the established data path based at least in part on the determining whether traffic should be directed via the first network or via the second network.

10. The method of claim 1, wherein the second network employs a network protocol different from a network protocol employed by the first network.

11. The method of claim 1, wherein the route request message is a path request message (PREQ) according to a hybrid wireless mesh protocol (HWMP).

12. An apparatus for communication networking, comprising:
a processor;
memory in electronic communication with the processor; and
instructions stored in the memory and executable by the processor to cause the apparatus to:
receive, at an edge device connected to a first network and a second network, a route request message from a source device over the first network;
identify, at the edge device, a destination device within the first network based at least in part on the route request message;
forward the route request message via the second network; and
determine, based at least in part the forwarded route request message, whether traffic between the source device and the destination device that is routed through the edge device should be directed via the first network or via the second network.

13. The apparatus of claim 12, wherein the instructions to determine whether traffic should be directed via the first network or via the second network are operable to:
receive a route reply message from the destination device, the route reply message based at least in part on the forwarded route request message.

14. The apparatus of claim 12, wherein the instructions to determine whether traffic should be directed via the first network or via the second network are operable to:
determine, based at least in part on the forwarded route request message, that a data path via the second network provides at least one of a favorable link metric, or minimum hop count, or a combination thereof between the source device and the destination device as compared to a data path via the first network.

15. The apparatus of claim 12, wherein the instructions to forward the route request message via the second network are operable to:
increment a hop count of the route request message.

16. The apparatus of claim 12, wherein the instructions to forward the route request message via the second network are operable to:
tunnel a packet comprising the route request message and having a format associated with a protocol employed by the first network inside a frame having a format associated with a protocol employed by the second network; and
broadcast the frame over the second network.

17. The apparatus of claim 16, wherein the frame comprises an identification that the source device and the destination device are within the first network.

18. The apparatus of claim 16, wherein the frame comprises at least one of a neighbor awareness network (NAN) cluster identification (ID), a NAN data link group ID, a mesh ID, a medium access control (MAC) address of the source device, or a MAC address of the destination device.

19. The apparatus of claim 12, wherein the instructions to determine whether traffic should be directed via the first network or via the second network are based at least in part on one or both of: a predetermined characteristic of a data path from the edge device to the destination device via the first network, or a predetermined characteristic of a data path from the edge device to the destination device via the second network.

20. The apparatus of claim 12, further comprising instructions stored in the memory and executable by the processor to cause the apparatus to:
receive, at the edge device, a data packet originating from the source device to be received by the destination device;
encapsulate the data packet inside a data frame having a format associated with the second network; and
forward the data frame from the edge device along an established data path via the second network, the established data path based at least in part on the determining whether traffic should be directed via the first network or via the second network.

21. The apparatus of claim 12, wherein the second network employs a network protocol different from a network protocol employed by the first network.

22. The apparatus of claim 12, wherein the route request message is a path request message (PREQ) according to a hybrid wireless mesh protocol (HWMP).

23. An apparatus for communication networking, comprising:
a processor;
memory in electronic communication with the processor; and
instructions stored in the memory and executable by the processor to cause the apparatus to:
receive, at an edge device connected to a first network and a second network, a frame via the second network;
extract, from the frame, a packet comprising a route request message from a source device of the first network to a destination device of the first network; and
forward, via the first network, the packet comprising the route request message via the first network.

24. The apparatus of claim 23, further comprising instructions stored in the memory and executable by the processor to cause the apparatus to:
receive a data frame at the edge device;
determine the destination device based at least in part on the data frame;
extract a data packet from the data frame; and
forward the data packet along an established data path from the edge device via the first network, the established data path based at least in part on the forwarded packet comprising the route request message.

25. The apparatus of claim 23, wherein the second network employs a network protocol different from a network protocol employed by the first network.

26. The apparatus of claim 23, wherein the route request message is a path request message (PREQ) according to a hybrid wireless mesh protocol (HWMP).

27. An apparatus for communication networking, comprising:
a first receiver for receiving, at an edge device connected to a first network and a second network, a route request message from a source device over the first network;
a destination identifier for identifying, at the edge device, a destination device within the first network based at least in part on the route request message;
a transmitter for forwarding the route request message via the second network; and
a heterogeneous network communications manager for determining, based at least in part on the forwarded route request message, whether traffic between the source device and the destination device that is routed through the edge device should be directed via the first network or via the second network.

28. The apparatus of claim 27, further comprising:
a second receiver for receiving, at the edge device, a route reply message from the destination device, the route reply message based at least in part on the forwarded route request message.

29. The apparatus of claim 27, wherein the heterogeneous network communications manager is configured to:
tunnel a packet comprising the route request message and having a format associated with a protocol employed by the first network inside a frame having a format associated with a protocol employed by the second network.

30. The apparatus of claim 29, wherein the transmitter is configured to:
broadcast the frame over the second network.
